(19) United States
(12) Patent Application Publication
(10) Pub. No.: US 2009/0252992 A1
(43) Pub. Date: Oct. 8, 2009

(54) MAGNETIC RECORDING MEDIUM AND METHOD OF FABRICATING THE SAME

(75) Inventors: Makoto Okada, Higashine (JP); Takuya Tomoi, Higashine (JP); Eishin Yamakawa, Higashine (JP); Yuki Yoshida, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/488,188

(22) Filed: Jun. 19, 2009

Related U.S. Application Data
(63) Continuation of application No. PCT/JP2007/053431, filed on Feb. 23, 2007.

(51) Int. Cl. G11B 5/71; B05D 5/12

(52) U.S. Cl. 428/846; 427/127

(57) ABSTRACT

A magnetic recording medium has a recording layer, a protection layer and a lubricant layer that are stacked above a substrate. The lubricant layer includes a bond layer in contact with the protection layer, and a mobile layer at a surface of the magnetic recording medium and having a bonding strength weaker than that of the bond layer with respect to the protection layer. A height of convex portions at a surface portion of the mobile layer is approximately 0.3 nm or less.

### CROSS-REFERENCE TO RELATED APPLICATIONS

This application is a continuation application filed under 35 U.S.C. 111(a) claiming the benefit under 35 U.S.C. 120 and 365(c) of a PCT International Application No. PCT/JP2007/053431 filed Feb. 23, 2007, in the Japanese Patent Office, the disclosure of which is hereby incorporated by reference.

### FIELD

The present invention generally relates to magnetic recording media and methods of fabricating the same, and more particularly to a magnetic recording medium having a lubricant layer and a method of fabricating such a magnetic recording medium.

### BACKGROUND

In magnetic recording media typified by magnetic disks, there are increased demands to further improve the recording density year by year. In order to satisfy such demands for high magnetic recording density, a flying height of a head from a magnetic disk surface has become approximately 10 nm which is extremely small. For this reason, a margin of the head flying height has also become small, and the head is more likely to make contact with the magnetic disk surface at the time of the recording or reproduction. In addition, in the head having a Dynamic Flying Height (DFH) function, the head flying height constantly varies depending on a projecting amount of an element part, and the flying height has decreased to the order of several nm.

The general magnetic disk employing the horizontal or perpendicular magnetic recording has a stacked structure having an underlayer, a recording layer, a protection layer and a lubricant layer that are successively stacked on a substrate. The lubricant layer that is provided at a surface portion of the magnetic disk is formed by coating the lubricant layer on the protection layer by a dipping process, for example, and thereafter subjecting the lubricant layer to a baking process to improve the molecular orientation of the lubricant layer. As a result, the lubricant layer on the side of the protection layer is formed by a bond layer, while the lubricant layer at the surface portion of the magnetic disk is formed by a mobile layer. The bond layer is strongly bonded to the protection layer, which is made of Diamond-Like Carbon (DLC), for example, by the baking process. For this reason, the bond layer is unlikely to separate or become peeled off from the protection layer even when the head makes contact with the magnetic disk surface. In addition, the film thickness of the bond layer increases due to the baking process. On the other hand, the mobile layer easily separates or becomes peeled off when the head makes contact with the magnetic disk surface, and the separated mobile layer is likely to adhere on the head. This is because, unlike the bond layer, the mobile layer is the surface portion of the lubricant layer that is not strongly bonded to the protection layer, and the surface of the mobile layer has undulations and is not an ideal planar (or flat) surface. In other words, the head having the extremely small head flying height may easily make contact with convex portions of the undulations at the surface of the mobile layer. However, the mobile layer is essential in order to secure the durability of the magnetic disk.

The so-called Head Disk Interference (HDI) occurs due to the above described contact between the head and the mobile layer. The HDI also occurs when foreign particles exist on the mobile layer, and the separated portions of the mobile layer may become such foreign particles. FIG. 1 is a cross sectional view for explaining adsorption of the mobile layer on the head. In FIG. 1, the magnetic disk includes a recording layer 1, a protection layer 2 and a lubricant layer 3, and the lubricant layer 3 includes a bond layer 3A and a mobile layer 3B. A reference numeral 3B-1 denotes the mobile layer 3B adsorbed or adhered on a head 6, and a reference numeral 4 denotes a foreign particle existing on the mobile layer 3B.

Various magnetic recording media provided with a lubricant layer, and methods of fabricating magnetic recording media have been proposed, including Japanese Laid-Open Patent Publications No. 3-153645, No. 2006-12215 and No. 2006-48801, and International Application Publication WO01/001403.

The film thickness of the mobile layer of the lubricant layer is desirably thin from the point of view of suppressing the adsorption to the head, but the durability of the magnetic recording medium deteriorates if no mobile layer is provided. For this reason, although it is desirable to control the film thickness of the mobile layer to a thin value, it was difficult to stably control the film thickness of the mobile layer to a thin value according to the conventional fabricating method.

Hence, in the conventional magnetic recording media, the mobile layer forming the surface portion of the lubricant layer is easily adsorbed on the head, and the tendency of the mobile layer becoming adsorbed on the head became more notable as the head flying height decreased.

### SUMMARY

Accordingly, it is an object in one aspect of the invention to provide a magnetic recording medium and a method of fabricating the same, in which adsorption of a mobile layer forming a surface portion of a lubricant layer onto a head is suppressed.

One aspect of the present invention is to provide a magnetic recording medium comprising a substrate; and a recording layer, a protection layer and a lubricant layer that are stacked above the substrate, wherein the lubricant layer includes a bond layer in contact with the protection layer, and a mobile layer at a surface of the magnetic recording medium and having a bonding strength weaker than that of the bond layer with respect to the protection layer, and a height of convex portions at a surface portion of the mobile layer is approximately 0.3 nm or less.

According to one aspect of the present invention, there is provided a method of fabricating a magnetic recording medium comprising forming a lubricant layer on a protection layer of the magnetic recording medium, so that the lubricant layer includes a bond layer in contact with the protection layer, and a mobile layer at a surface of the magnetic recording medium and having a bonding strength weaker than that of the bond layer with respect to the protection layer; and rinsing the lubricant layer on the protection layer by a rinsing process in order to reduce a film thickness of the mobile layer.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a cross sectional view for explaining adsorption of a mobile layer on a head;

FIG. 2 is a cross sectional view illustrating a basic structure of a magnetic recording medium in an embodiment of the present invention;

FIG. 3 is a diagram illustrating a dependency of a mobile layer ratio with respect to a head flying height;

FIG. 4 is a diagram illustrating a dependency of the mobile layer ratio with respect to a durability of the magnetic recording medium;

FIG. 5 is a diagram for explaining a method of fabricating the magnetic recording medium in an embodiment of the present invention;

FIG. 6 is a diagram for explaining the method of fabricating the magnetic recording medium in another embodiment of the present invention;

FIGS. 7A and 7B are diagram for explaining a surface state of a lubricant layer formed by a conventional fabricating method;

FIGS. 8A and 8B are diagrams for explaining a surface state of a lubricant layer formed by a fabricating method in accordance with an embodiment of the present invention;

FIG. 9 is a diagram illustrating results that are plotted when a Pin On Disk (POD) durability test is performed with respect to a magnetic disk formed by the conventional fabricating method and a magnetic disk formed by the fabricating method in accordance with an embodiment of the present invention; and

FIG. 10 is a diagram illustrating results that are plotted when a durability test is performed using a head of an actual storage apparatus with respect to the magnetic disk formed by the conventional fabricating method and the magnetic disk formed by the fabricating method in accordance with the embodiment of the present invention.

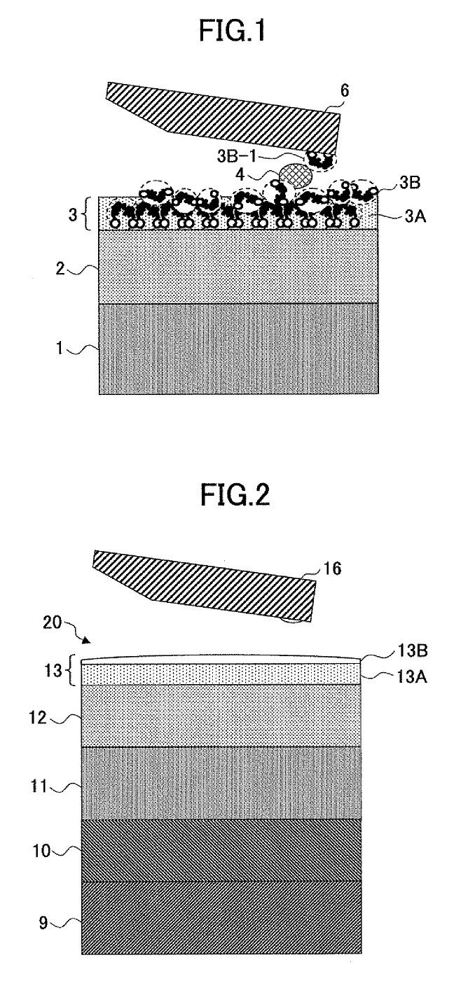

### DESCRIPTION OF EMBODIMENTS

Preferred embodiments of the present invention will be described with reference to the accompanying drawings.

According to one aspect of the present invention, adsorption of a mobile layer forming a surface portion of a lubricant layer onto a head is suppressed.

A description will now be given of a magnetic recording medium and a method of fabricating the same, in each embodiment according to the present invention.

FIG. 2 is a cross sectional view illustrating a basic structure of a magnetic recording medium in an embodiment of the present invention. A magnetic recording medium 20 illustrated in FIG. 2 includes an underlayer 10, a recording layer 11, a protection layer 12, and a lubricant layer 13 that are successively stacked on a substrate 9. The magnetic recording medium 20 forms a magnetic disk, for example, and employs the horizontal or perpendicular magnetic recording. The recording layer 11 is made of a magnetic material, and the protection layer 12 is made of DLC, for example. The lubricant layer 13 is formed by a bond layer 13A which bonds satisfactorily on the protection layer 12, and a mobile layer 13B having a weaker bonding strength with respect to the protection layer 12 than the bond layer 13A. The surface of the mobile layer 13B is planar or flat compared to the mobile layer of the conventional magnetic recording medium. For example, a ratio of the film thickness of the bond layer 13A with respect to the total film thickness of the lubricant layer 13 is approximately 70% or less, and the ratio of the film thickness of the mobile layer 13B with respect to the total film thickness of the lubricant layer 13 is approximately 30% or less.

In one embodiment of the present invention, the film thickness of the mobile layer 13B of the lubricant layer 13 is decreased by a rinsing process in order to improve the flatness of the surface of the mobile layer 13B. Hence, it is possible to reduce the undulations at the surface of the mobile layer 13B, and stably control the film thickness of the mobile layer 13B. For this reason, even if the head flying height of a head 16 decreases, it is possible to suppress adsorption of the mobile layer 13B forming the surface portion of the lubricant layer 13 onto the head 16. Furthermore, because the film thickness of the mobile layer 13B can be stably controlled to a thin value, it is possible to positively secure the durability of the magnetic recording medium 20.

Of course, the structure between the recording layer 11 and the substrate 9 is not limited to the structure illustrated in FIG. 2.

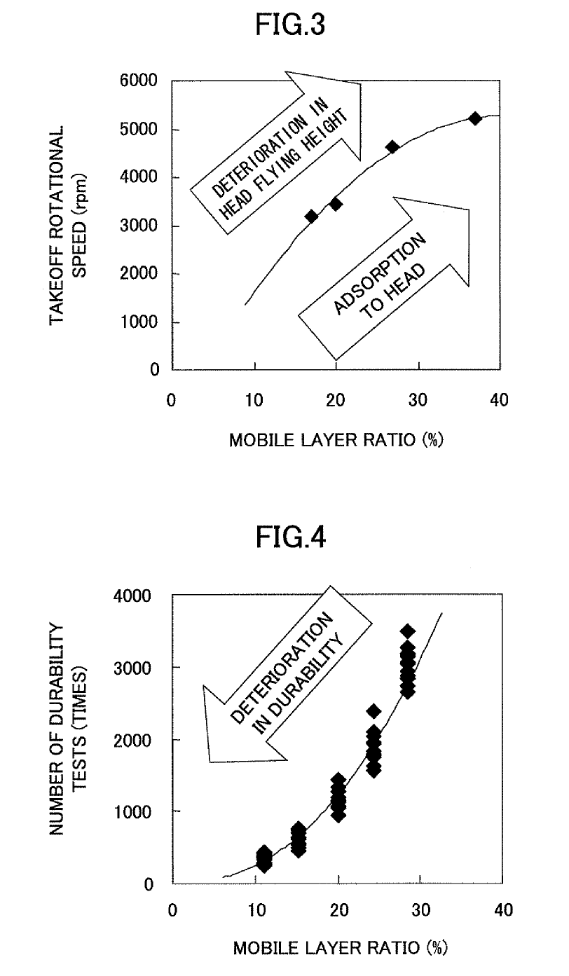

FIG. 3 is a diagram illustrating a dependency of the mobile layer ratio with respect to the head flying height. FIG. 4 is a diagram illustrating a dependency of the mobile layer ratio with respect to the durability of the magnetic recording medium 20. FIGS. 3 and 4 illustrate the characteristics for the case where the magnetic recording medium 20 is the magnetic disk. In each of FIGS. 3 and 4, the abscissa indicates the mobile layer ratio, which is a ratio of the film thickness of the mobile layer 13B with respect to the total film thickness of the lubricant layer 13. The ordinate in FIG. 3 indicates a takeoff rotational speed (or number of revolutions) of a touch-and-takeoff test, and the ordinate in FIG. 4 indicates the number of times a Pin On Disk (POD) durability test is performed. In addition, the plots in FIG. 3 correspond to points where the head 16 does not make contact with the magnetic disk, for a case where the film thickness of the bond layer 13A is approximately 0.6 nm to approximately 1.2 nm and the film thickness of the mobile layer 13B is approximately 0.1 nm to approximately 0.5 nm.

As may be seen from FIG. 3, the takeoff rotational speed increases as the mobile layer ratio increases, and the head flying height decreases (or deteriorates) and the adsorption of the mobile layer 13B onto the head 16 increases unless the takeoff rotational speed is high. In addition, as may be seen from FIG. 4, if the mobile layer ratio decreases, the number of acceptable test results until a break occurs in the layers decreases and the durability of the magnetic disk deteriorates. Accordingly, suppressing the adsorption of the mobile layer 13B onto the head 16 and maintaining or improving the durability of the magnetic disk are in a tradeoff relationship when viewed from the point of view of the dependency on the mobile layer ratio. When this tradeoff relationship is taken into consideration, the mobile layer ratio is desirably in a range of approximately 5% to approximately 40%. Moreover, from the point of view of suppressing the total film thickness of the lubricant layer 13 to approximately 1.7 nm or less, the mobile layer ratio is desirably in a range of approximately 5% to approximately 30%. Furthermore, from the point of view of suppressing the height of the convex portions of the undulations at the surface of the mobile layer 13B to approximately 0.3 nm or less, for example, the mobile layer ratio is desirably in a range of approximately 5% to approximately 10%.

Next, a description will be given of the method of fabricating the magnetic recording medium 20 in the case where the magnetic recording medium 20 is the magnetic disk.

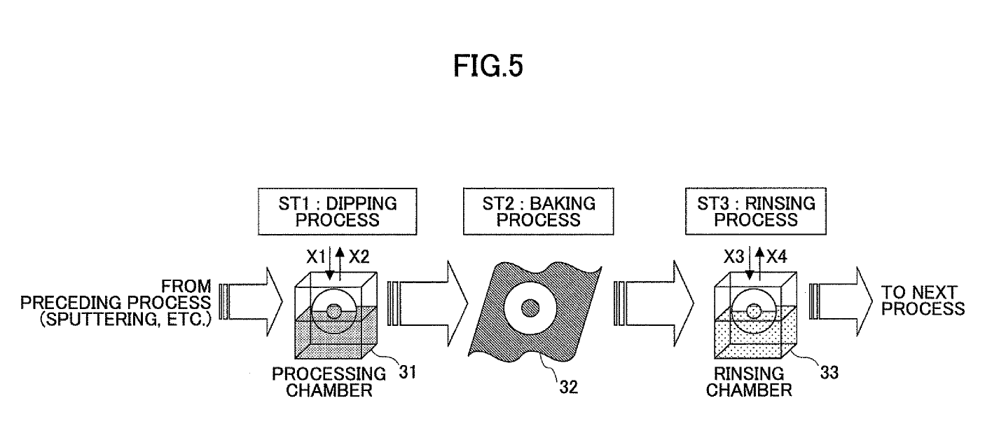

FIG. 5 is a diagram for explaining the method of fabricating the magnetic recording medium in an embodiment of the present invention. As illustrated in FIG. 5, it is assumed for the sake of convenience that the structure of the magnetic recording medium 20 up to the protection layer 12 has already been formed by sputtering or the like on the substrate 9 performed in preceding processes.

A step ST1 carries out a dipping process to coat the lubricant layer 13 on the protection layer 12. In this dipping process, the magnetic disk having the structure up to the protection layer 12 already formed on the substrate 9 thereof by the preceding processes is dipped into a processing chamber 31 which contains a lubricant made of a fluoric material, in a direction X1, and is then pulled out from the processing chamber 31 in a direction X2. The fluoric material may be Fomblin Z-Tetraol, Z-Dol or AM3001 respectively manufactured by Solvay Solexis, for example. The wait time (or dip time) of the magnetic disk within the processing chamber 31 was controlled in the step ST1 so that the final mobile layer ratio becomes approximately 5% to approximately 40%.

A step ST2 carries out a known baking process to heat the magnetic disk which is coated with the lubricant layer 13, within a backing chamber 32, in order to improve the molecular orientation of the lubricant layer 13. As a result, the bond layer 13A was formed in the lubricant layer 13 on the side of the protection layer 12, while the mobile layer 13B was formed in the lubricant layer 13 at the surface portion of the magnetic disk. The bond layer 13A is strongly bonded on the protection layer 12 by the baking process. In this example, the steps ST1 and ST2 form a lubricant forming process to form the lubricant layer 13.

A step ST3 carries out a rinsing process to decrease the film thickness of the mobile layer 13B and improve the flatness of the surface of the mobile layer 13B. In this rinsing process, the magnetic disk having the structure up to the lubricant layer 13 already formed on the substrate 9 thereof and subjected to the baking process described above is dipped into a rinsing chamber 33 which contains a rinsing liquid made of a fluoric solvent or pure water, in a direction X3, and is then pulled out from the rinsing chamber 33 in a direction X4. As a result, the undulations at the surface of the mobile layer 13B are reduced, and the film thickness of the mobile layer 13B is stably controlled. The fluoric solvent may be FC77/FC3255/HFE730 manufactured by 3M Company, Vertrel-XF manufactured by DuPont or, H-Galden manufactured by Solvay Solexis, for example. After the step ST3 which forms the rinsing process, the magnetic disk is subjected to a test or the like in a next process. Of course, a single chamber (or tank) may be used as the processing chamber 31 and the rinsing chamber 33.

In this embodiment, the rinsing liquid within the rinsing chamber 33 was maintained in a range of approximately 20° C. to approximately 25° C. in order to suppress volatilization of the fluoric solvent in the case where the fluoric solvent is used as the rinsing liquid. In addition, in order not to be affected by the surface wave of the rinsing liquid when the magnetic disk is dipped into the rinsing liquid, the wait time (or dip time) of the magnetic disk within the rinsing chamber 33 was set in a range of approximately 10 seconds to approximately 30 seconds. Moreover, in order not to be affected by the surface wave of the rinsing liquid when the magnetic disk is pulled out of the rinsing liquid, the pull speed was set in a range of approximately 50 mm/sec to approximately 200 mm/sec, where “mm/sec” denotes millimeters per second. Further, during the wait time (or dip time) of the magnetic disk within the rinsing chamber 33, the rinsing process was promoted by ultrasonic oscillation.

Accordingly, a magnetic disk having the bond layer 13A with a film thickness of approximately 0.6 nm to approximately 1.2 nm and the mobile layer 13B with a film thickness of approximately 0.1 nm to approximately 0.5 nm was fabricated. According to experiments conducted by the present inventors, it was confirmed that in order to suppress the total film thickness of the lubricant layer 13 to approximately 1.7 nm or less, the mobile layer ratio is desirably approximately 5% to approximately 30%. It was also confirmed that in order to suppress the height of the convex portions of the undulations at the surface of the mobile layer 13B to approximately 0.3 nm or less, for example, the mobile layer ratio is more desirably approximately 5% to approximately 10%.

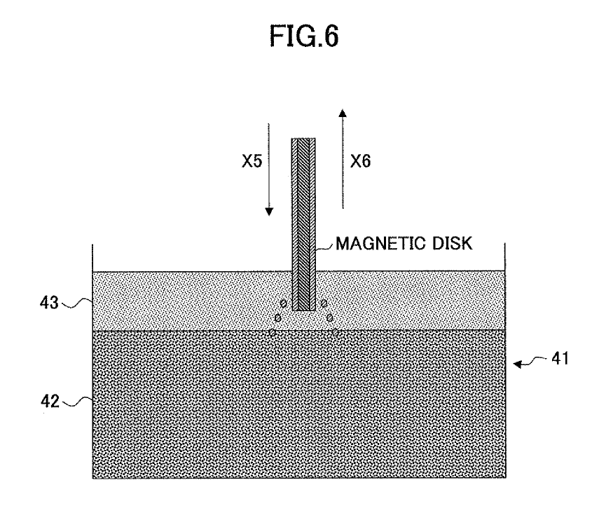

FIG. 6 is a diagram for explaining the method of fabricating the magnetic recording medium in another embodiment of the present invention. As illustrated in FIG. 6, it is assumed for the sake of convenience that the structure of the magnetic recording medium 20 up to the protection layer 12 has already been formed by sputtering or the like on the substrate 9 performed in preceding processes.

For example, the magnetic disk having the structure up to the protection layer 12 already formed on the substrate 9 thereof by the preceding processes is simultaneously subjected to a lubricant forming process and a rinsing process by use of a single processing chamber 41. The processing chamber 41 contains a lubricant 42 made of a fluoric material and a rinsing liquid 43. Hence, when a dipping process is carried out to dip the magnetic disk into the processing chamber 41 in a direction X5 and then to pull out the magnetic disk in a direction X6, the lubricant layer 13 is coated on the protection layer 12 at the time of dipping the magnetic disk, and the rinsing process is carried out with respect to the lubricant layer 13 at the time of pulling out the magnetic disk. The fluoric material used for the lubricant 42 and the fluoric solvent or pure water used for the rinsing liquid 43 may be the same as those used in the embodiment described above. According to this embodiment, the magnetic disk can be fabricated in a short time at a low cost when compared to the embodiment described above.

In the case of the embodiment illustrated in FIG. 6, no baking process is carried out. For this reason, the bonding strength of the bond layer 13A with respect to the protection layer 12 is slightly smaller when compared to that when the baking process is carried out, but no inconveniences are introduced from the practical point of view. In addition, the film thickness of the bond layer 13A will not be increased because no baking process is carried out. However, the film thickness of the mobile layer 13B may be reduced by the rinsing process in order to increase the relative film thickness of the bond layer 13A with respect to the total film thickness of the lubricant layer 13. This, no inconveniences are introduced from the practical point of view by the fact that the film thickness of the bond layer 13A will not be increased because no baking process is carried out.

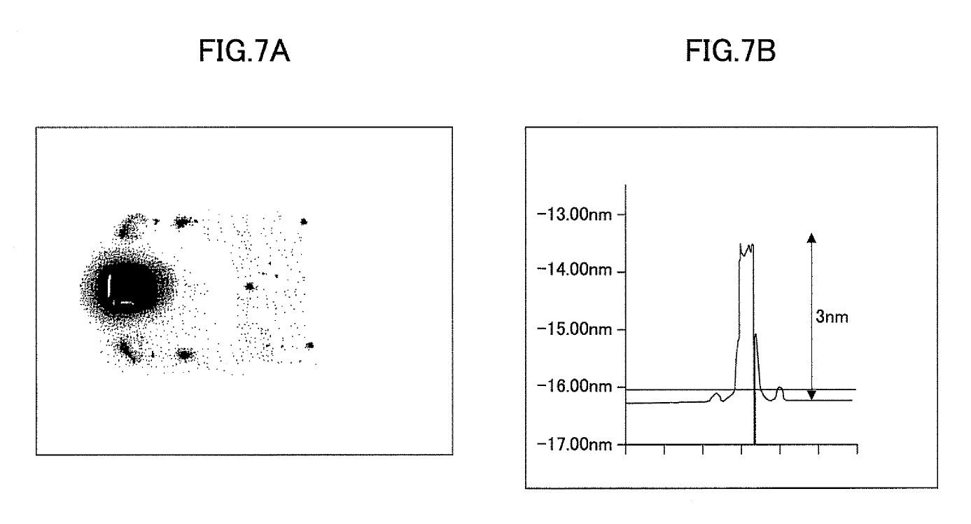

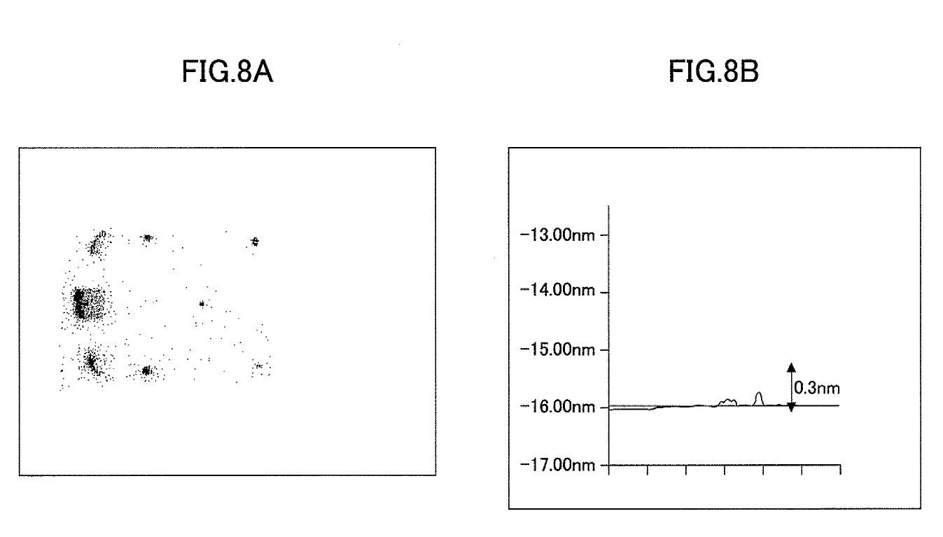

FIGS. 7A and 7B are diagram for explaining a surface state of a lubricant layer formed by a conventional fabricating method, and FIGS. 8A and 8B are diagrams for explaining a surface state of the lubricant layer formed by the fabricating method in accordance with the embodiment of the present invention.

FIGS. 7A and 7B illustrate the surface state of the lubricant layer of the magnetic disk that is fabricated under conditions similar to those of the embodiment described above with reference to FIG. 5, but by only carrying out the steps ST1 and ST2 illustrated in FIG. 5 as in the case of the conventional fabricating method. FIG. 7A illustrates a plan-view image of the surface of the lubricant layer that is obtained by Optical Surface Analysis (OSA), in which a white portion indicates the flat surface, and a dark portion indicates the height of the convex portion of the undulations at the surface of the lubricant layer with the dark portion becoming darker as the height increases. FIG. 7B illustrates the surface portion of the mobile layer on an enlarged scale in a cross section of the magnetic disk. It may be seen from FIG. 7B that a maximum height of the convex portion of the undulations at the surface of the mobile layer, that is, the maximum height from the flat surface of the mobile layer, is approximately 3 nm. In this case, if the head flying height is 10 nm or less, for example, the head is likely to make contact with the lubricant layer and the probability of the mobile layer becoming adsorbed on the head increases.

On the other hand, FIGS. 8A and 8B illustrate the surface state of the lubricant layer of the magnetic disk that is fabricated under conditions of the embodiment described above with reference to FIG. 5 by carrying out the steps ST1, ST2 and ST3 illustrated in FIG. 5 or, under the conditions of the other embodiment described above with reference to FIG. 6. FIG. 8A illustrates a plan-view image of the surface of the lubricant layer 13 that is obtained by Optical Surface Analysis (OSA), in which a white portion indicates the flat surface, and a dark portion indicates the height of the convex portion of the undulations at the surface of the lubricant layer 13 with the dark portion becoming darker as the height increases. FIG. 8B illustrates the surface portion of the mobile layer 13B on an enlarged scale in a cross section of the magnetic disk. It may be seen from FIG. 8B that a maximum height of the convex portion of the undulations at the surface of the mobile layer 13B, that is, the maximum height from the flat surface of the mobile layer 13B, is approximately 0.3 nm. In this case, the maximum height of the convex portion of the undulations at the surface of the mobile layer 13B is suppressed to approximately 1/10 that for the case where the conventional fabricating method is used. For this reason, even if the head flying height of the head 16 is 10 nm or less, for example, it was confirmed that the head 16 is unlikely to make contact with the lubricant layer 13 and the probability of the mobile layer 13B becoming adsorbed on the head 16 becomes extremely low.

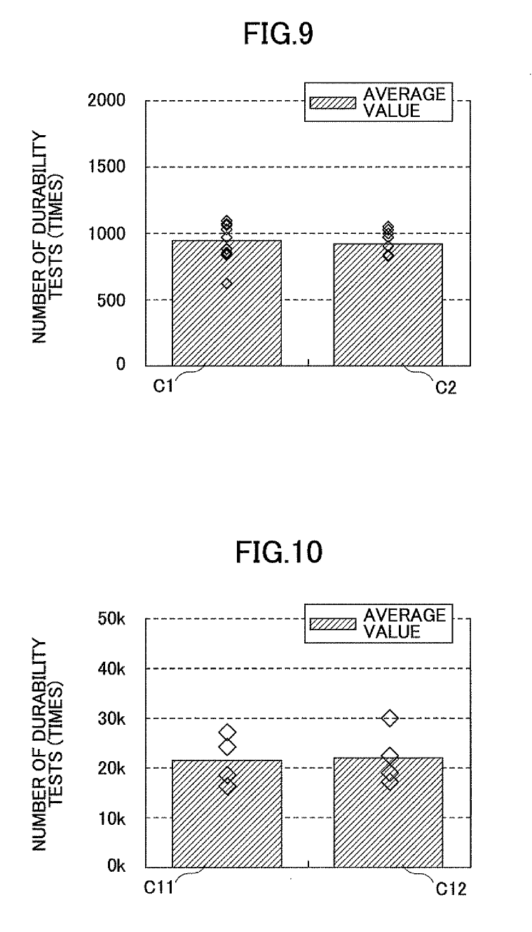

FIG. 9 is a diagram illustrating results that are plotted when a Pin On Disk (POD) durability test, similar to that described above with reference to FIG. 4, is performed with respect to the magnetic disk formed by the conventional fabricating method and the magnetic disk formed by the fabricating method in accordance with the embodiment of the present invention. The conventional fabricating method fabricated the magnetic disk under conditions similar to those of the embodiment described above with reference to FIG. 5, but by only carrying out the steps ST1 and ST2 illustrated in FIG. 5. On the other hand, the fabricating method in accordance with the embodiment of the present invention fabricated the magnetic disk under conditions of the embodiment described above with reference to FIG. 5 by carrying out the steps ST1, ST2 and ST3 illustrated in FIG. 5 or, under the conditions of the other embodiment described above with reference to FIG. 6. In FIG. 9, the ordinate indicates the number of times the Pin On Disk (POD) durability test is performed, C1 denotes an average value of the durability test results with respect to the magnetic disk formed by the conventional fabricating method, and C2 denotes an average value of the durability test results with respect to the magnetic disk formed by the fabricating method in accordance with the embodiment of the present invention. As may be seen from FIG. 9, no notable deterioration in the durability of the magnetic disk was observed by carrying out the rinsing process in accordance with the embodiment of the present invention.

FIG. 10 is a diagram illustrating results that are plotted when a durability test is performed using the head 16 of an actual storage apparatus with respect to the magnetic disk formed by the conventional fabricating method and the magnetic disk formed by the fabricating method in accordance with the embodiment of the present invention. The conventional fabricating method fabricated the magnetic disk under conditions similar to those of the embodiment described above with reference to FIG. 5, but by only carrying out the steps ST1 and ST2 illustrated in FIG. 5. On the other hand, the fabricating method in accordance with the embodiment of the present invention fabricated the magnetic disk under conditions of the embodiment described above with reference to FIG. 5 by carrying out the steps ST1, ST2 and ST3 illustrated in FIG. 5 or, under the conditions of the other embodiment described above with reference to FIG. 6. In FIG. 10, the ordinate indicates the number of times the Pin On Disk (POD) durability test is performed using the head 16, C11 denotes an average value of the durability test results with respect to the magnetic disk formed by the conventional fabricating method using the head 16, and C2 denotes an average value of the durability test results with respect to the magnetic disk formed by the fabricating method in accordance with the embodiment of the present invention using the head 16. As may be seen from FIG. 10, no notable deterioration in the durability of the magnetic disk was observed by carrying out the rinsing process in accordance with the embodiment of the present invention. Rather, it was confirmed that the durability of the magnetic disk slightly improves by carrying out the rinsing process.

In other words, according to each of the embodiments described above, it was confirmed that the adsorption of the mobile layer 13B, forming the surface portion of the lubricant layer 13, onto the head 16 is suppressed even when the head flying height of the head 16 decreases. In addition, because the film thickness of the mobile layer 13B can be stably controlled to a thin value, it was also confirmed that the durability of the magnetic disk is positively secured.

Therefore, embodiments of the present invention are applicable to various magnetic storage apparatuses, such as magnetic disk drives, in which the head flying height is extremely small.

All examples and conditional language recited herein are intended for pedagogical purposes to aid the reader in understanding the invention and the concepts contribute by the inventor to furthering the art, and are to be construed as being without limitation to such specifically recited examples and conditions, nor does the organization of such examples in the specification related to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A magnetic recording medium comprising:
a substrate; and
a recording layer, a protection layer and a lubricant layer that are stacked above the substrate,
wherein the lubricant layer includes a bond layer in contact with the protection layer, and a mobile layer at a surface of the magnetic recording medium and having a bonding strength weaker than that of the bond layer with respect to the protection layer, and
a height of convex portions at a surface portion of the mobile layer is approximately 0.3 nm or less.

2. The magnetic recording medium as claimed in claim 1, wherein a ratio of a film thickness of the mobile layer with respect to a total film thickness of the lubricant layer is approximately 5% to approximately 10%.

3. The magnetic recording medium as claimed in claim 1, wherein the lubricant layer is made of a fluoric material.

4. A method of fabricating a magnetic recording medium comprising:
forming a lubricant layer on a protection layer of the magnetic recording medium, so that the lubricant layer includes a bond layer in contact with the protection layer, and a mobile layer at a surface of the magnetic recording medium and having a bonding strength weaker than that of the bond layer with respect to the protection layer; and
rinsing the lubricant layer on the protection layer by a rinsing process in order to reduce a film thickness of the mobile layer.

5. The method of fabricating the magnetic recording medium as claimed in claim 4, wherein said forming coats the lubricant layer on the protection layer by a dipping process, and increases the bonding strength of the bond layer with respect to the protection layer and increases a film thickness of the bond layer by a baking process.

6. The method of fabricating the magnetic recording medium as claimed in claim 5, wherein:
the lubricant layer is made of a fluoric material; and
said rinsing process dips the magnetic recording medium in a fluoric solvent or pure water.

7. The method of fabricating the magnetic recording medium as claimed in claim 6, wherein said forming and said rinsing are carried out so that a ratio of the film thickness of the mobile layer with respect to a total film thickness of the lubricant layer is approximately 5% to approximately 40%.

8. The method of fabricating the magnetic recording medium as claimed in claim 7, wherein said rinsing controls a height of convex portions at a surface portion of the mobile layer to approximately 0.3 nm or less.

9. The method of fabricating the magnetic recording medium as claimed in claim 6, wherein said forming and said rinsing are carried out so that the bond layer is formed to a thickness of approximately 0.6 nm to approximately 1.2 nm and the mobile layer is formed to a thickness of approximately 0.1 nm to approximately 0.5 nm.

10. The method of fabricating the magnetic recording medium as claimed in claim 4, wherein said forming and said rinsing are carried out by dipping the magnetic recording medium in a single processing chamber containing a rinsing liquid on top of a lubricant, in order to coat the lubricant on the protection layer and reduce the film thickness of the mobile layer by the rinsing liquid.

11. The method of fabricating the magnetic recording medium as claimed in claim 10, wherein the lubricant is made of a fluoric material, and the rinsing liquid is made of a fluoric solvent or pure water.

12. The method of fabricating the magnetic recording medium as claimed in claim 11. wherein said forming and said rinsing are carried out so that a ratio of the film thickness of the mobile layer with respect to a total film thickness of the lubricant layer is approximately 5% to approximately 40%.

13. The method of fabricating the magnetic recording medium as claimed in claim 12, wherein said rinsing controls a height of convex portions at a surface portion of the mobile layer to approximately 0.3 nm or less.

14. The method of fabricating the magnetic recording medium as claimed in claim 11, wherein said forming and said rinsing are carried out so that the bond layer is formed to a thickness of approximately 0.6 nm to approximately 1.2 nm and the mobile layer is formed to a thickness of approximately 0.1 nm to approximately 0.5 nm.
